(19) United States
(12) Patent Application Publication
(10) Pub. No.: US 2025/0232204 A1
(43) Pub. Date: Jul. 17, 2025

(54) Noise Mitigation in Dynamic Quantum Circuits by Inserting Context-Dependent Dynamical Decoupling Sequences

(71) Applicant: International Business Machines Corporation, Armonk, NY (US)

(72) Inventors: Derek WANG, New York, NY (US); Patrick Julian Tassilo RALL, Boston, MA (US); Edward Hong CHEN, San Jose, CA (US); Seyed Alireza SEIF TABRIZI, Adelphi, MD (US); Maika TAKITA, Croton-on-Hudson, NY (US); Thomas ALEXANDER, Halifax (CA); Elisa Doreen BÄUMER, Zurich (CH); Swarnadeep MAJUMDER, Durham, NC (US); Zlatko Kristev MINEV, White Plains, NY (US); Diego RISTÈ, Watertown, MA (US); Vinay TRIPATHI, Los Angeles, CA (US)

(21) Appl. No.: 18/410,716

(22) Filed: Jan. 11, 2024

(51) Int. Cl. G06N 10/70

(52) U.S. Cl. CPC G06N 10/70

(57) ABSTRACT

A method, system, and computer program product for implementing noise mitigation in dynamic quantum circuits. A condition in a dynamic quantum circuit is identified. A condition refers to a situation or circumstance used to identify or detect a source of noise in the dynamic quantum circuit that may result in an error occurring in the dynamic quantum circuit. For example, the condition may correspond to the idling times, spectator qubits, and idling qubits in cross-talk resistant states (quantum states [symbol] and [symbol] in the dynamic quantum circuit. Based on the identified condition, a context-dependent dynamical decoupling sequence is inserted in the dynamic quantum circuit. A context-dependent dynamical decoupling sequence refers to a dynamical decoupling sequence that is inserted in the dynamic quantum circuit based on the context, such as the occurrence of a particular operation (e.g., mid-circuit measurement, the occurrence of a feed-forward operation, the occurrence of qubit shuttling).

### TECHNICAL FIELD

The present disclosure relates generally to dynamic quantum circuits, and more particularly to implementing noise mitigation in dynamic quantum circuits by inserting context-dependent dynamical decoupling sequences.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

A plethora of quantum algorithms have been traditionally formulated as static quantum circuits, where the computation is performed on an initially prepared quantum state, and all measurements are applied at the end of the circuit to extract the computational results. However, the recent advancements in quantum hardware have paved the way for a more flexible approach, allowing for measurements and qubit resets to be executed in the midst of a quantum circuit. Such quantum circuits are referred to as “dynamic quantum circuits” in that such circuits involve the evolution of the quantum state throughout the computation, periodic measurements of qubits mid-circuit (mid-circuit measurements) and concurrent processing of the resulting classical information on timescales shorter than the execution times of the circuits. Furthermore, dynamic quantum circuits allow “feed-forward operations,” which correspond to the real-time adaptation of the quantum circuit based on earlier measurement outcomes.

Dynamic quantum circuits, as opposed to static quantum circuits, use less quantum resources thereby making quantum computations more efficient and less prone to decoherence (qubits of the computation become entangled with the environment). Furthermore, dynamic quantum circuits can transform large-depth circuits (depth of a quantum circuit is a measure of how many “layers” of quantum gates, executed in parallel, it takes to complete the computation defined by the circuit) into constant-depth circuits, which has an advantage in certain situations, such as preparing the Greenberger-Horne-Zeilinger state (type of entangled quantum state that involves at least three subsystems (particle states, qubits, or qudits)), gate teleportation (applying a quantum gate on an unknown state while it is being teleported), etc.

Dynamic quantum circuits though, just like static quantum circuits, are subject to errors due to noise. However, dynamic quantum circuits are subject to errors due to noise in different manners that have not yet been adequately addressed. For example, during a mid-circuit measurement, a measurement performed on a qubit may result in dephasing on the other qubits connected to the same readout bus. In another example, during the feed-forward operation, ZZ crosstalk and decoherence may accumulate. ZZ crosstalk originates from a mixing between computational states and higher-energy states of the coupled qubits. It shifts the resonance frequency of one qubit conditionally on the state of another qubit. As a result, spurious phases are accumulated during gate operations, reducing fidelities. Quantum decoherence is the loss of quantum coherence, the process in which a system's behavior changes from what which can be explained by quantum mechanics to that which can be explained by classical mechanics.

Unfortunately, there is not currently an effective means for suppressing or mitigating such types of noise (e.g., ZZ crosstalk, decoherence) in dynamic quantum circuits.

### SUMMARY

In one embodiment of the present disclosure, a method for implementing noise mitigation in dynamic quantum circuits comprises identifying a condition in a dynamic quantum circuit. The method further comprises inserting a context-dependent dynamical decoupling sequence in the dynamic quantum circuit based on the identified condition.

Additionally, in one embodiment of the present disclosure, the condition comprises one of the following in the group consisting of an idling time, spectator qubits and idling qubits in cross-talk resistant states in the dynamic quantum circuit.

Furthermore, in one embodiment of the present disclosure, the dynamical decoupling sequence is inserted in the dynamic quantum circuit during a mid-circuit measurement.

Additionally, in one embodiment of the present disclosure, the dynamical decoupling sequence is inserted in the dynamic quantum circuit during an occurrence of a feed-forward operation.

Furthermore, in one embodiment of the present disclosure, the dynamical decoupling sequence is inserted in the dynamic quantum circuit during an occurrence of qubit shuttling or qubit swapping.

Additionally, in one embodiment of the present disclosure, the dynamical decoupling sequence is inserted in the dynamic quantum circuit during an occurrence of a unitary gate in the dynamic quantum circuit.

Furthermore, in one embodiment of the present disclosure, the method additionally comprises scheduling the dynamic quantum circuit to be executed upon decomposing the dynamic quantum circuit into native gates and mapping of the dynamic quantum circuit onto a native topology, where the condition is identified in the scheduled dynamic quantum circuit.

Other forms of the embodiments of the method described above are in a system and in a computer program product.

Accordingly, embodiments of the present disclosure effectively mitigate noise in dynamic quantum circuits.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for effectively mitigating noise in dynamic quantum circuits in accordance with an embodiment of the present disclosure;

FIG. 3 illustrates a diagram of a dynamic quantum circuit in accordance with an embodiment of the present disclosure;

FIGS. 4A-4C illustrate inserting a dynamical decoupling sequence during a mid-circuit measurement in accordance with an embodiment of the present disclosure;

FIGS. 5A-5C illustrate extending the feed-forward time while inserting dynamical decoupling sequences on the qubits in accordance with an embodiment of the present disclosure;

FIG. 6 illustrates inserting staggered dynamical decoupling sequences on the qubits in accordance with an embodiment of the present disclosure;

FIG. 7 illustrates an embodiment of the present disclosure of the hardware configuration of the classical computer which is representative of a hardware environment for practicing the present disclosure; and

FIG. 8 is a flowchart of a method for effectively implementing noise mitigation in dynamic quantum circuits in accordance with an embodiment of the present disclosure.

### DETAILED DESCRIPTION

In one embodiment of the present disclosure, a method for implementing noise mitigation in dynamic quantum circuits comprises identifying a condition in a dynamic quantum circuit. The method further comprises inserting a context-dependent dynamical decoupling sequence in the dynamic quantum circuit based on the identified condition.

In this manner, noise is effectively mitigated in dynamic quantum circuits.

Additionally, in one embodiment of the present disclosure, the condition comprises one of the following in the group consisting of an idling time, spectator qubits and idling qubits in cross-talk resistant states in the dynamic quantum circuit.

In this manner, a condition, corresponding to a situation or circumstance used to identify or detect a source of noise in the dynamic quantum circuit that may result in an error occurring in the dynamic quantum circuit, is identified. For example, the condition may correspond to the idling times, spectator qubits, and idling qubits in cross-talk resistant states (quantum states |0 [symbol] and |1 [symbol] in the dynamic quantum circuit.

Furthermore, in one embodiment of the present disclosure, the dynamical decoupling sequence is inserted in the dynamic quantum circuit during a mid-circuit measurement.

In this manner, dynamical decoupling sequences (sequences of qubit gates) are utilized to suppress the dephasing introduced by a readout bus during mid-circuit measurements as well as the large idling errors accumulated during long mid-circuit measurements.

Additionally, in one embodiment of the present disclosure, the dynamical decoupling sequence is inserted in the dynamic quantum circuit during an occurrence of a feed-forward operation.

In this manner, dynamical decoupling sequences (sequences of qubit gates) are utilized to mitigate noise, such as decoherence and cross-talk, during feed-forward operations.

Furthermore, in one embodiment of the present disclosure, the dynamical decoupling sequence is inserted in the dynamic quantum circuit during an occurrence of qubit shuttling or qubit swapping.

In this manner, dynamical decoupling sequences (sequences of qubit gates) are utilized to mitigate noise, such as decoherence and cross-talk, during qubit shuttling or qubit swapping operations.

Additionally, in one embodiment of the present disclosure, the dynamical decoupling sequence is inserted in the dynamic quantum circuit during an occurrence of a unitary gate in the dynamic quantum circuit.

In this manner, dynamical decoupling sequences (sequences of qubit gates) are utilized to mitigate noise, such as decoherence and cross-talk, during the occurrence of a unitary gate in the dynamic quantum circuit.

Furthermore, in one embodiment of the present disclosure, the method additionally comprises scheduling the dynamic quantum circuit to be executed upon decomposing the dynamic quantum circuit into native gates and mapping of the dynamic quantum circuit onto a native topology, where the condition is identified in the scheduled dynamic quantum circuit.

In this manner, context-dependent dynamical decoupling sequences may be utilized to mitigate noise in scheduled dynamic quantum circuits in response to identifying a condition, such as idling times, spectator qubits, and idling qubits in cross-talk resistant states (quantum states |0 [symbol] and |1 [symbol] ), in the dynamic quantum circuit.

Other forms of the embodiments of the method described above are in a system and in a computer program product.

As stated above, a plethora of quantum algorithms have been traditionally formulated as static quantum circuits, where the computation is performed on an initially prepared quantum state, and all measurements are applied at the end of the circuit to extract the computational results. However, the recent advancements in quantum hardware have paved the way for a more flexible approach, allowing for measurements and qubit resets to be executed in the midst of a quantum circuit. Such quantum circuits are referred to as “dynamic quantum circuits” in that such circuits involve the evolution of the quantum state throughout the computation, periodic measurements of qubits mid-circuit (mid-circuit measurements) and concurrent processing of the resulting classical information on timescales shorter than the execution times of the circuits. Furthermore, dynamic quantum circuits allow “feed-forward operations,” which correspond to the real-time adaptation of the quantum circuit based on earlier measurement outcomes.

Dynamic quantum circuits, as opposed to static quantum circuits, use less quantum resources thereby making quantum computations more efficient and less prone to decoherence (qubits of the computation become entangled with the environment). Furthermore, dynamic quantum circuits can transform large-depth circuits (depth of a quantum circuit is a measure of how many “layers” of quantum gates, executed in parallel, it takes to complete the computation defined by the circuit) into constant-depth circuits, which has an advantage in certain situations, such as preparing the Greenberger-Horne-Zeilinger state (type of entangled quantum state that involves at least three subsystems (particle states, qubits, or qudits)), gate teleportation (applying a quantum gate on an unknown state while it is being teleported), etc.

Dynamic quantum circuits though, just like static quantum circuits, are subject to errors due to noise. However, dynamic quantum circuits are subject to errors due to noise in different manners that have not yet been adequately addressed. For example, during a mid-circuit measurement, a measurement performed on a qubit may result in dephasing on the other qubits connected to the same readout bus. In another example, during the feed-forward operation, ZZ crosstalk and decoherence may accumulate. ZZ crosstalk originates from a mixing between computational states and higher-energy states of the coupled qubits. It shifts the resonance frequency of one qubit conditionally on the state of another qubit. As a result, spurious phases are accumulated during gate operations, reducing fidelities. Quantum decoherence is the loss of quantum coherence, the process in which a system's behavior changes from what which can be explained by quantum mechanics to that which can be explained by classical mechanics.

Unfortunately, there is not currently an effective means for suppressing or mitigating such types of noise (e.g., ZZ crosstalk, decoherence) in dynamic quantum circuits.

The embodiments of the present disclosure provide the means for effectively implementing noise mitigation in dynamic quantum circuits by identifying a condition in a scheduled dynamic quantum circuit, such as idling times, spectator qubits, and idling qubits in cross-talk resistant states (quantum states |0 [symbol] and |1 [symbol] ) . Idling times, as used herein, refer to locations in the dynamic quantum circuit where no operations are being performed. Spectator qubits, as used herein, refer to qubits with the role of measuring outside noise rather than storing data. Idling qubits, as used herein, refer to those qubits that are not currently being processed by the dynamic quantum circuit. Upon identifying such a condition in the dynamic quantum circuit, a context-dependent dynamical decoupling sequence is inserted in the dynamic quantum circuit based on the identified condition. A dynamical decoupling sequence, as used herein, is an open-loop quantum control technique employed in quantum computing to suppress noise, such as cross-talk, decoherence, etc. For example, in one embodiment, a dynamical decoupling sequence corresponds to a sequence of qubit gates to suppress unwanted noise, such as cross-talk, decoherence, etc. A “context-dependent” dynamical decoupling sequence, as used herein, refers to a dynamical decoupling sequence that is inserted in the dynamic quantum circuit based on the context, such as the occurrence of a particular operation. For example, the dynamical decoupling sequence is inserted in the dynamic quantum circuit during a mid-circuit measurement, the occurrence of a feed-forward operation, the occurrence of qubit shuttling (the ability to move qubits while preserving their quantum state), the occurrence of qubit swapping (moving information from one qubit to another non-adjacent qubit), and the occurrence of a unitary gate in the dynamic quantum circuit. In this manner, noise is effectively mitigated in dynamic quantum circuits. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

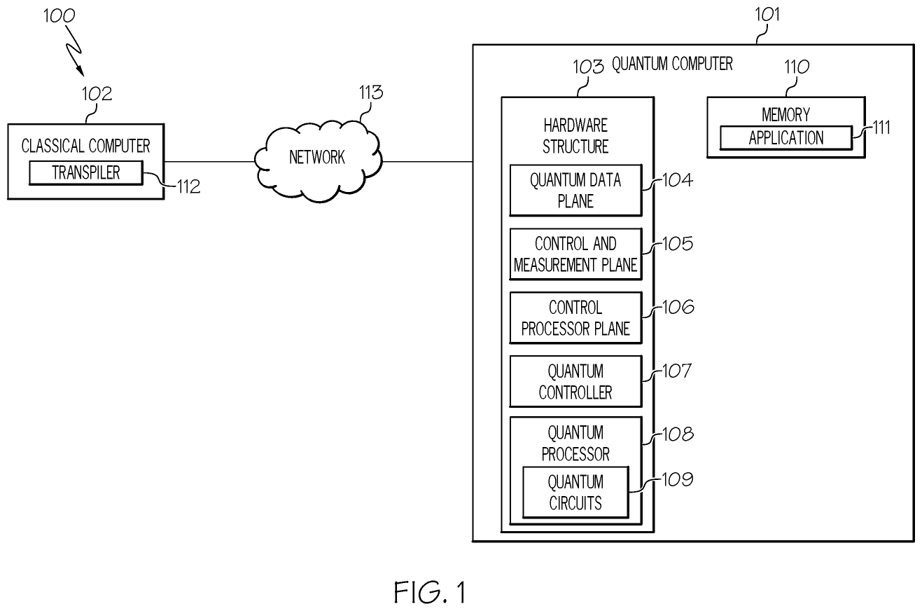

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to effectively mitigate noise in dynamic quantum circuits as discussed further below.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

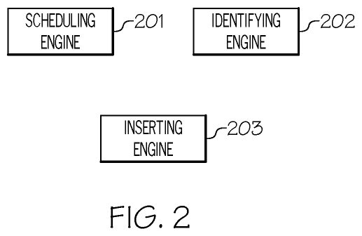

In one embodiment, memory 110 stores an application 111 that may be configured to implement one or more of the methods described herein in accordance with one or more embodiments. For example, application 111 may implement a program for effectively mitigating noise in dynamic quantum circuits as discussed further below in connection with FIGS. 2-3, 4A-4C, 5A-5C, 6 and 8. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

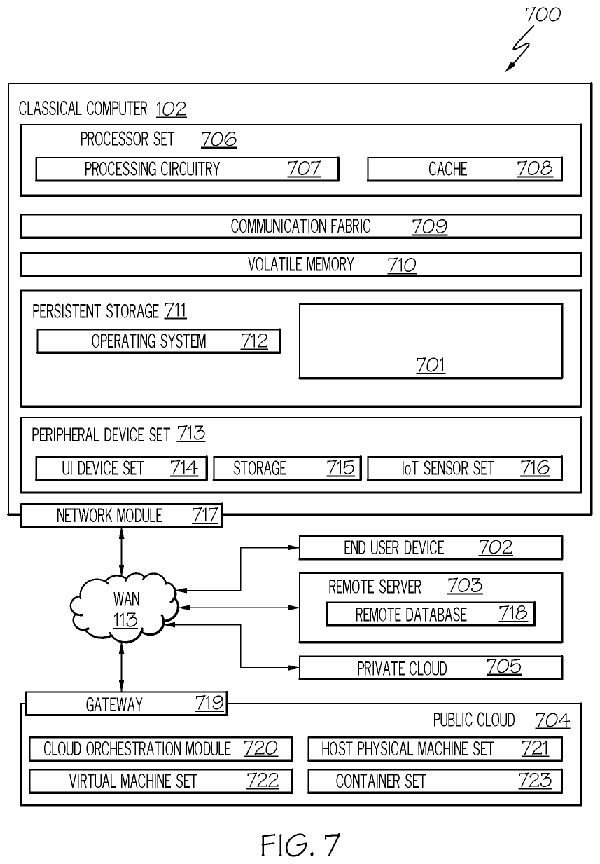

Furthermore, classical computer 102 is configured to effectively mitigate noise in dynamic quantum circuits as discussed further below in connection with FIGS. 2-3, 4A-4C, 5A-5C, 6 and 8. A description of the software components of classical computer 102 is provided below in connection with FIG. 2 and a description of the hardware configuration of classical computer 102 is provided further below in connection with FIG. 7.

System 100 is not to be limited in scope to any one particular network architecture. System 100 may include any number of quantum computers 101, classical computers 102, and networks 113.

A discussion regarding the software components used by classical computer 102 for effectively mitigating noise in dynamic quantum circuits is provided below in connection with FIG. 2.

FIG. 2 is a diagram of the software components of classical computer 102 (FIG. 1) for effectively mitigating noise in dynamic quantum circuits in accordance with an embodiment of the present disclosure.

Referring to FIG. 2, in conjunction with FIG. 1, classical computer 102 includes a scheduling engine 201 configured to schedule the dynamic quantum circuit to be executed upon decomposing the dynamic quantum circuit into native gates and mapping of the dynamic quantum circuit onto a native topology. In one embodiment, scheduling engine 201 uses the scheduler function of Qiskit® (e.g., qiskit.scheduler) to schedule a dynamic quantum circuit to be executed upon decomposing the dynamic quantum circuit into native gates and mapping of the dynamic quantum circuit onto a native topology. In one embodiment, the scheduler function (qiskit_ibm_provider.transpiler.passes.scheduling) of Qiskit® issues scheduling passes which determine when the dynamic quantum circuit is executed.

In one embodiment, scheduling engine 201 utilizes a function (IBMBackend) of Qiskit® to apply transformations and optimizations for the hardware backend when transpiling (process of rewriting a given input circuit to match the topology of a specific quantum device and/or to optimize the quantum circuit for execution on noisy quantum systems). In one embodiment, scheduling engine 201 utilizes the qiskit.transpiler function of Qiskit® to perform such transpilation.

In one embodiment, scheduling engine 201 utilizes the scheduler function of Qiskit® (e.g., qiskit.scheduler) to optimize execution of the dynamic quantum circuit by adjusting gate times and orders based on mid-circuit measurements.

Classical computer 102 further includes an identifying engine 202 configured to identify a condition in the scheduled dynamic quantum circuit resulting in noise that may lead to errors. A “condition,” as used herein, refers to a situation or circumstance used to identify or detect a source of noise in the dynamic quantum circuit that may result in an error occurring in the dynamic quantum circuit. For example, the condition may correspond to the idling times, spectator qubits, and idling qubits in cross-talk resistant states (quantum states |0 [symbol] and |1 [symbol] ) in the dynamic quantum circuit.

Idling times, as used herein, refer to locations in the dynamic quantum circuit where no operations are being performed. During such a situation, a qubit may be susceptible to idling errors, which occur when the qubit is idle and not actively undergoing any operations.

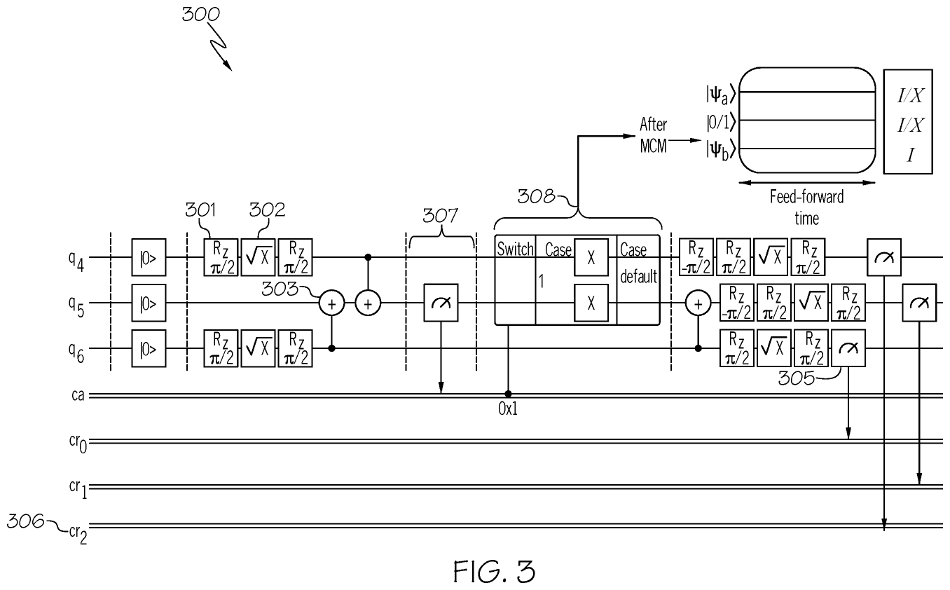

Identifying engine 202 identifies idling times by scanning the dynamic quantum circuit for idle periods of time. In one embodiment, identifying engine 202 identifies idling times based on the duration of the instruction on the qubits, which may be obtained from the InstructionDurations function of Qiskit®. After obtaining the duration of the instruction on the qubits, idling times may then be identified when an operation is not being performed. An illustration of identifying an idling time is provided in FIG. 3.

Referring to FIG. 3, FIG. 3 illustrates a diagram of dynamic quantum circuit 300 in accordance with an embodiment of the present disclosure.

As shown in FIG. 3, dynamic quantum circuit 300 includes rotation gates 301 (e.g., R_{z}), SX gates 302 (performs the rotation about the X-axis of the Bloch Sphere by 90° or π/2 radians in the counter-clockwise direction), and entangling 2-qubit CNot gates 303 operating on the spaces of qubits 304 (e.g., q₄, q₅, q₆).

FIG. 3 further illustrates measurements being performed using measurement operators 305, which output the result as classical information on readout busses 306 (e.g., ca, cr₀, cr₁, cr₂).

Additionally, as shown in FIG. 3, an idling time 307 is identified in which an idling and dephasing error may occur. For example, qubit q₅ undergoes a mid-circuit measurement; however, qubits q₄ and q₆ undergo dephasing due to the sharing of the readout bus. Furthermore, as illustrated in FIG. 3, after the measurement of qubit q₅, which is either in the quantum state of |0 [symbol] or |1 [symbol] , qubit q₅ is not prone to crosstalk or dephasing errors. However, during feed-forward operation 308, which occurs after the mid-circuit measurement, qubits q₄ and q₆ are prone to crosstalk and dephasing errors.

Returning to FIG. 2, in conjunction with FIGS. 1 and 3, spectator qubits, as used herein, refer to qubits with the role of measuring outside noise rather than storing data. Such spectator qubits, which are co-located together with the data qubits that are used in the computation, may be utilized for noise detection. For example, the spectator qubits are not participating in the quantum computation itself, meaning that they will not become entangled with the data qubits. Instead, the spectator qubits can be used to monitor noise that would affect the data qubits. Since the spectator qubits are co-located with the data qubits, they can experience the same noise that the data qubits experience. As a result, in one embodiment, identifying engine 202 performs a measurement on spectator qubits to estimate what that noise is in real-time when a quantum computation is running on the data qubits. This noise measurement is then used to detect noise occurring in the dynamic quantum circuit. In such an embodiment, the noise, the spectator qubit and the data qubit experience are correlated.

In one embodiment, identifying engine 202 identifies spectator qubits in the scheduled dynamic quantum circuit based on the information provided by scheduling engine 201, which may designate certain qubits of the dynamic quantum circuit to correspond to the spectator qubits based on input from a user.

Idling qubits, as used herein, refers to those qubits that are not currently being processed by the dynamic quantum circuit. Cross-talk resistant states, as used herein, refer to those states, such as quantum states |0 [symbol] and |1 [symbol] , that prevent cross-talk from occurring in the dynamic quantum circuit.

In one embodiment, identifying engine 202 identifies idling qubits in the cross-talk resistant states by identifying idling times for qubits based on scanning the dynamic quantum circuit for idle periods of time or based on the duration of the instruction on the qubits, which may be obtained from the InstructionDurations function of Qiskit®, and then obtaining the measurements of the quantum states for the qubits during such idling times from measurement operators (e.g., measurement operator 305).

Furthermore, classical computer 102 includes inserting engine 203 configured to insert a context-dependent dynamical decoupling sequence in the dynamic quantum circuit based on the identified condition, such as idling times, spectator qubits or idling qubits in cross-talk resistant states, in the dynamic quantum circuit.

A dynamical decoupling sequence, as used herein, is an open-loop quantum control technique employed in quantum computing to suppress noise, such as cross-talk, decoherence, etc. For example, in one embodiment, a dynamical decoupling sequence corresponds to a sequence of qubit gates to suppress unwanted noise, such as cross-talk, decoherence, etc. A “context-dependent” dynamical decoupling sequence, as used herein, refers to a dynamical decoupling sequence that is inserted in the scheduled dynamic quantum circuit based on the context, such as the occurrence of particular operations. As discussed further below, such particular operations include mid-circuit operations, the occurrence of a feed-forward operation, the occurrence of qubit sharing, the occurrence of qubit swapping, and the occurrence of a unitary gate in the dynamic quantum circuit.

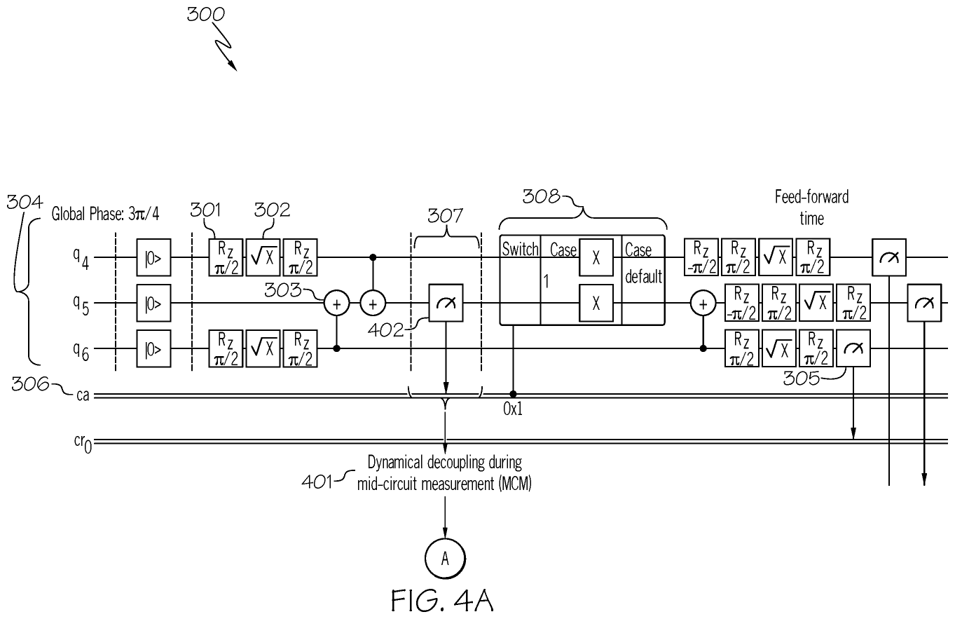

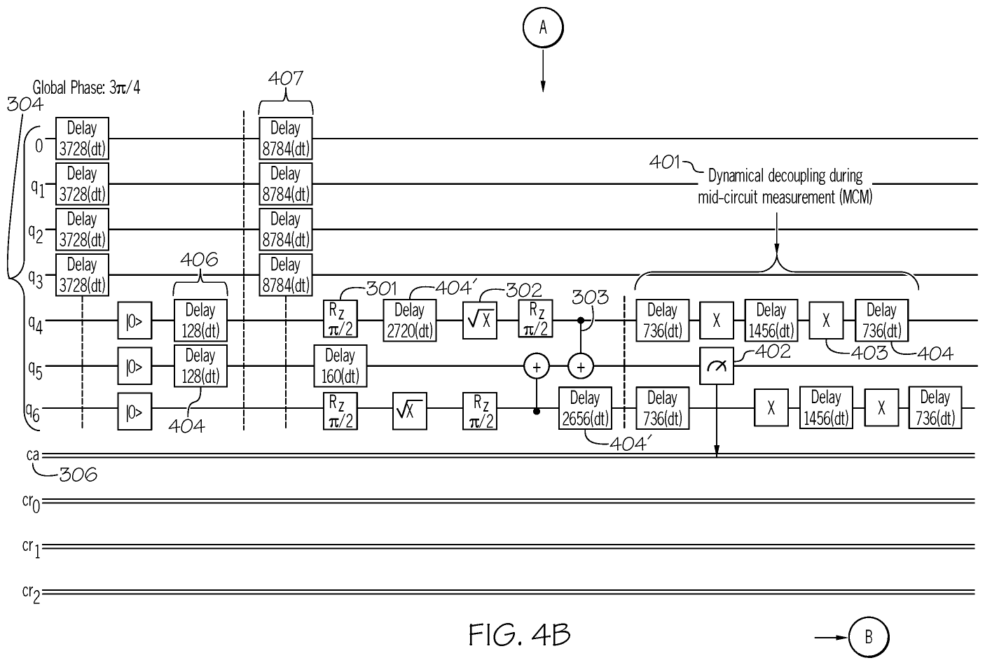

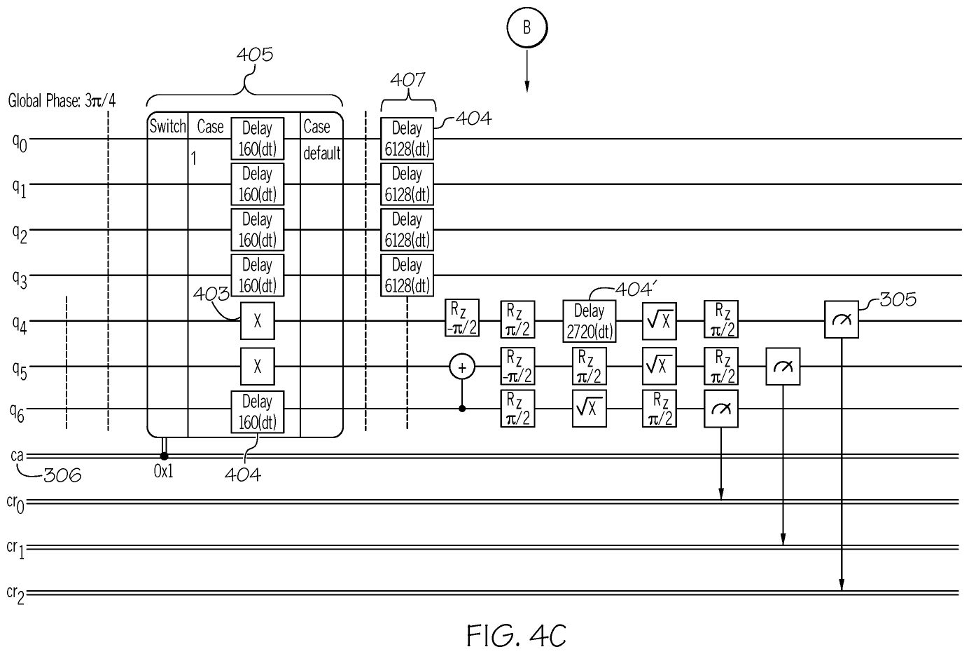

In one embodiment, inserting engine 203 inserts the dynamical decoupling sequence in the dynamic quantum circuit during a mid-circuit measurement. A “mid-circuit measurement,” as used herein, refers to a measurement that occurs within the middle of the quantum circuit, i.e., the measurement does not occur at the beginning or end of the quantum circuit. Dynamical decoupling sequences (sequences of qubit gates) may be utilized to suppress the dephasing introduced by a readout bus (e.g., readout bus 306 of FIG. 3) during mid-circuit measurements as well as the large idling errors, such as from the condition of idling time or idling qubits, accumulated during long mid-circuit measurements. As a result, a dynamical decoupling sequence may be inserted in the dynamic quantum circuit during a mid-circuit measurement as illustrated in FIGS. 4A-4C.

Referring to FIGS. 4A-4C, FIGS. 4A-4C illustrate inserting a dynamical decoupling sequence during a mid-circuit measurement in accordance with an embodiment of the present disclosure.

As illustrated in FIGS. 4A-4C, a dynamical decoupling sequence 401 is inserted in dynamic quantum circuit 300 during idling time 307, which occurs during a mid-circuit measurement performed by measurement operator 402. In one embodiment, inserting engine 203 identifies such a mid-circuit measurement based on identifying measurement operator 402 performing a mid-circuit measurement. In one embodiment, inserting engine 203 identifies such a measurement operator 402 by analyzing the operators, such as measurement operators, created using the Operator function of Qiskit®, and then identifying such measurement operators that are scheduled to perform mid-circuit measurements.

As discussed above, inserting engine 203 is configured to insert dynamical decoupling sequence 401 during a mid-circuit measurement performed by measurement operator 402. Such a dynamical decoupling sequence 401 may include a sequence of quantum gates, such as Pauli X gates 403 and delay gates 404. In one embodiment, the sequence of quantum gates amount to the identity (I) so that they do not alter the logical action of the dynamic quantum circuit, but they have the effect of mitigating noise, such as decoherence, cross-talk, etc.

In one embodiment, inserting engine 203 inserts dynamical decoupling sequence 401 in dynamic quantum circuit 300 using the DynamicalDecoupling function of Qiskit® in which the dynamical decoupling sequence (sequence of gates to be applied) is specified as a parameter (e.g., dd_sequence).

In one embodiment, inserting engine 203 inserts dynamical decoupling sequence 401 in dynamic quantum circuit 300 using a dynamical decoupling insertion pass which works on a scheduled dynamic quantum circuit. Such a dynamical decoupling insertion pass may be implemented using the PadDynamicalDecoupling function of Qiskit®.

Furthermore, in one embodiment, inserting engine 203 inserts the dynamical decoupling sequence in the dynamic quantum circuit during the occurrence of a feed-forward operation.

In one embodiment, since no quantum gates can be applied during the feed-forward time (T), the same feed-forward time (T) is added so that for the two-qubit case, one has (X⊗I)f_{T}(X⊗I)f_{T}, where f_{T}=exp(-iH_{sys}T) , which is the free evolution for the system for time T.

In one embodiment, the second qubit is measured so that it is in either in the quantum state of |0 [symbol] or |1 [symbol] . Furthermore, by applying X pulses on the first qubit, ZZ crosstalk and decoherence are suppressed on the first qubit.

In one embodiment, such a procedure can be extended to a larger quantum circuit, such as the scheduled dynamic quantum circuit. For example, when every other qubit is measured, and the connectivity is such that all the qubits lie on a 1-dimensional chain, the feed-forward time can be extended, such as to 2 or 4 times T while inserting staggered dynamical decoupling sequences on all the qubits. Such a process may be implemented for the heavy-hex lattice architecture (each unit cell of the lattice consists of a hexagonal arrangement of qubits, with an additional qubit on each edge) as well as the square lattice architecture (e.g., four superconducting qubits on a chip roughly one-quarter-inch square) with different sequences and delays.

An illustration of inserting engine 203 inserting a dynamical decoupling sequence in a feed-forward operation is provided in FIGS. 4A-4C.

Referring to FIGS. 4A-4C, a dynamical decoupling sequence 405 is inserted in dynamic quantum circuit 300 during feed-forward operation 308. In one embodiment, inserting engine 203 identifies such a feed-forward operation (e.g., feed-forward operation 308 of FIGS. 3 and 4A-4C) by analyzing the operators, such as operators to perform a feed-forward operation, created using the Operator function of Qiskit®, and then identifying such operators that are scheduled to perform a feed-forward operation.

Furthermore, as shown in FIG. 4C, dynamical decoupling sequence 405 may include a sequence of quantum gates, such as Pauli X gates 403 and delay gates 404. In one embodiment, the sequence of quantum gates amount to the identity (I) so that they do not alter the logical action of the dynamic quantum circuit, but they have the effect of mitigating noise, such as decoherence, cross-talk, etc.

In one embodiment, inserting engine 203 inserts dynamical decoupling sequence 405 in dynamic quantum circuit 300 using the DynamicalDecoupling function of Qiskit® in which the dynamical decoupling sequence (sequence of gates to be applied) is specified as a parameter (e.g., dd_sequence).

In one embodiment, inserting engine 203 inserts dynamical decoupling sequence 405 in dynamic quantum circuit 300 using a dynamical decoupling insertion pass which works on a scheduled dynamic quantum circuit. Such a dynamical decoupling insertion pass may be implemented using the PadDynamicalDecoupling function of Qiskit®.

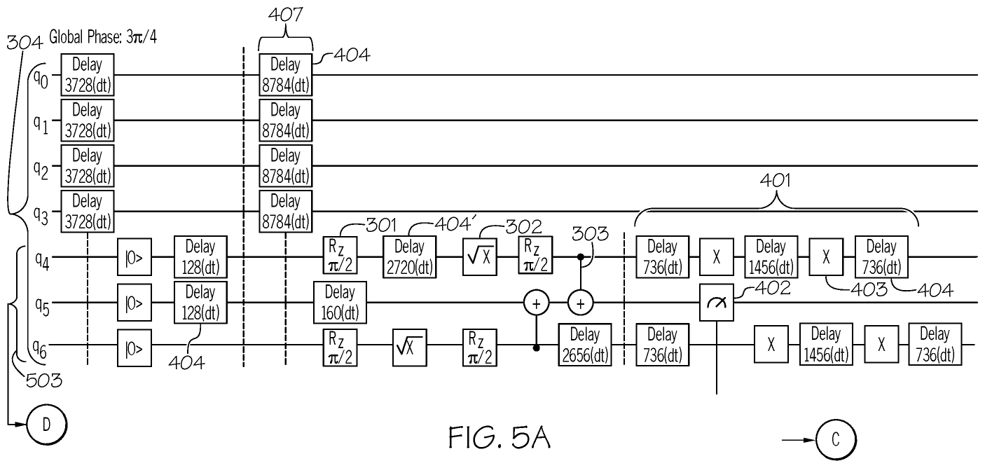

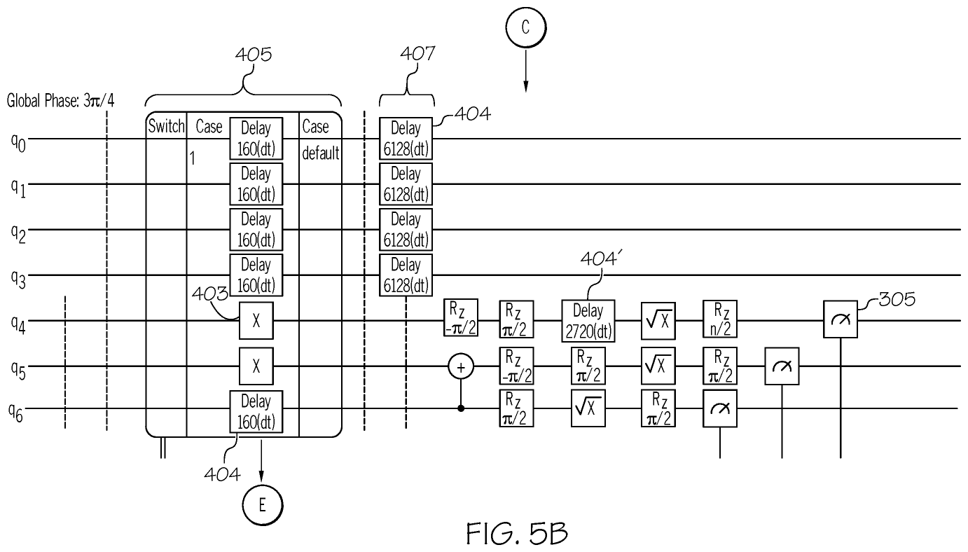

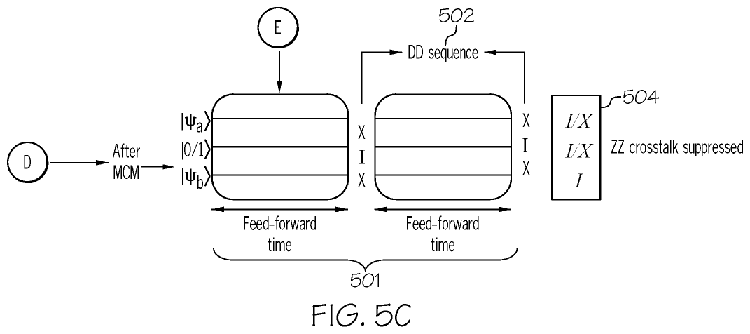

A further illustration of inserting engine 203 inserting dynamical decoupling sequence 405 in dynamic quantum circuit 300 is provided in FIGS. 5A-5C.

Referring to FIGS. 5A-5C, FIGS. 5A-5C illustrate extending the feed-forward time while inserting dynamical decoupling sequences on the qubits in accordance with an embodiment of the present disclosure.

As shown in FIGS. 5A-5C, the feed-forward time is extended (see element 501), such as to 2 times T, while applying the dynamical decoupling (DD) sequences (see element 502) to qubits q₄ and q₆ after a mid-circuit measurement (MCM) since q₅ is known to be in a computational state (following a projective measurement). In such an embodiment, noise, such as ZZ crosstalk, is suppressed (see element 504). In one embodiment, such a dynamical decoupling sequence (e.g., dynamical decoupling sequence 502) may include a sequence of quantum gates that amount to the identity (I) so that they do not alter the logical action of the dynamic quantum circuit, but they have the effect of mitigating noise, such as decoherence, cross-talk, etc.

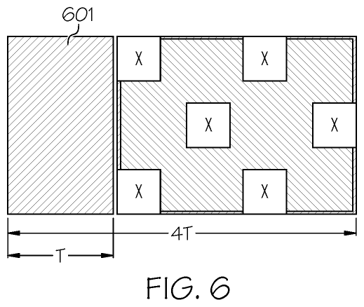

In the more general case, staggered dynamical decoupling sequences are inserted on the qubits. For example, when qubits q₄, q₅ and q₆ are all in an arbitrary state, a staggered dynamical decoupling sequence is inserted in dynamic quantum circuit 300. In such an embodiment, the idle time is extended to 4 times T so that the staggered dynamical decoupling sequences can be inserted on all the qubits as illustrated in FIG. 6.

FIG. 6 illustrates inserting staggered dynamical decoupling sequences on the qubits in accordance with an embodiment of the present disclosure.

Referring to FIG. 6, in conjunction with FIGS. 5A-5C, if qubits q₄, q₅ and q₆ are all in an arbitrary state and qubits q₄, q₅ and q₆ are coupled in a chain, then qubit q₆ may follow the same pattern as qubit q₄ (referred to herein as “Pattern A”) and qubit q₅ has its pulses (identified by the “Xs” in FIG. 6) staggered with respect to qubit q₄ (referred to herein as “Pattern B”). This is assuming that the connectivity is q₄₋9₅₋q₆, i.e., q₄ and q₆ are not coupled. It is noted that this factor of 4 in timing (the original latency, which is referred to as the switch latency T, corresponds to element 601) works for graphs when max connectivity=3, such as the heavy hex topology. In the embodiment discussed above, the graph can be divided into two subgraphs such that each qubit follows pattern A or B (and no coupled qubits have the same pattern). For larger connectivity, more sequences are necessary and the added delays are increased.

It is noted that FIG. 6 is not drawn to scale. Neglecting the durations of the X pulses, the spacings would be: X-2T-X-T for qubits q4 and q6 and T-X-T-X for qubit q₅.

In one embodiment, the application of the dynamical decoupling sequence may differ in the presence of ZZ coupling depending on the state of the coupled qubits. In one embodiment, if one of the two coupled qubits is in either the |0 [symbol] or |1 [symbol] quantum state (as opposed to an arbitrary state), then a dynamical decoupling sequence is not applied on that qubit. In such an embodiment, a dynamical decoupling sequence is applied on the other qubit, assuming that it is not coupled to any other qubit. If it is coupled to another qubit (third qubit), then the timing of the dynamical decoupling sequence is staggered, such as with respect to the third qubit.

If, however, both qubits are in an arbitrary state, then staggered dynamical decoupling sequences are applied on both qubits (e.g., same dynamical decoupling sequences are applied on both qubits but with staggered timing).

If, however, both qubits are in the |0 [symbol] or |1 [symbol] quantum state, then a dynamical decoupling sequence is not applied on them.

Returning to FIG. 2, in conjunction with FIGS. 1, 3, 4A-4C, 5A-5C and 6, in one embodiment, inserting engine 203 inserts the dynamical decoupling sequence in the dynamic quantum circuit during the occurrence of qubit shuttling. Qubit shuttling, as used herein, refers to the ability to move qubits while preserving their quantum state.

In one embodiment, inserting engine 203 identifies qubit shuttling by identifying a shuttling-based two-qubit logic gate in the dynamic quantum circuit. In one embodiment, inserting engine 203 identifies such logic gates by analyzing the operators, such as operators to perform a shuttling-based two-qubit logic gate, created using the Operator function of Qiskit®, and then identifying such operators that are scheduled to perform the shuttling-based two-qubit logic gate.

In another embodiment, inserting engine 203 identifies the shuttle operations in the quantum program to perform qubit shuttling. In one embodiment, inserting engine 203 identifies such shuttle operations by analyzing the operators, such as operators to perform a qubit shuttle operation, created using the Operator function of Qiskit®, and then identifying such operators that are scheduled to perform the qubit shuttling.

In one embodiment, inserting engine 203 inserts a dynamical decoupling sequence in the dynamic quantum circuit (e.g., dynamic quantum circuit 300) during the occurrence of qubit shuttling using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the dynamic quantum circuit (e.g., dynamic quantum circuit 300) during the occurrence of qubit shuttling using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of qubit shuttling is provided in FIG. 4B. As illustrated in FIG. 4B, a dynamical decoupling sequence, such as dynamical decoupling sequence 406 comprised of delay gates 404, is inserted during the occurrence of qubit shuttling. In one embodiment, such a dynamical decoupling sequence 406 may include a sequence of quantum gates that amount to the identity (I) so that they do not alter the logical action of the dynamic quantum circuit, but they have the effect of mitigating noise, such as decoherence, cross-talk, etc.

In one embodiment, inserting engine 203 inserts the dynamical decoupling sequence in the dynamic quantum circuit during the occurrence of qubit swapping. Qubit swapping, as used herein, refers to moving information from one qubit to another non-adjacent qubit.

In one embodiment, inserting engine 203 identifies qubit swapping by performing the swap test, which is a procedure in quantum computation that is used to check how much two quantum states differ. In one embodiment, the swap test is implemented in Qiskit®.

In one embodiment, inserting engine 203 identifies such swap operations by identifying swap gates (swaps the state of the two qubits involved in the operation) in the dynamic quantum circuit. In one embodiment, inserting engine 203 identifies such swap operations by analyzing the operators, such as operators to perform a qubit swap operation, created using the Operator function of Qiskit®, and then identifying such operators that are scheduled to perform the qubit swapping.

In one embodiment, inserting engine 203 inserts a dynamical decoupling sequence in the dynamic quantum circuit (e.g., dynamic quantum circuit 300) during the occurrence of qubit swapping using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the dynamic quantum circuit (e.g., dynamic quantum circuit 300) during the occurrence of qubit swapping using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of qubit swapping is provided in FIGS. 4B-4C. As illustrated in FIGS. 4B-4C, a dynamical decoupling sequence, such as dynamical decoupling sequence 407 comprised of delay gates 404, is inserted during the occurrence of qubit swapping. In one embodiment, such a dynamical decoupling sequence 407 may include a sequence of quantum gates that amount to the identity (I) so that they do not alter the logical action of the dynamic quantum circuit, but they have the effect of mitigating noise, such as decoherence, cross-talk, etc.

In one embodiment, inserting engine 203 inserts the dynamical decoupling sequence in the dynamic quantum circuit during the occurrence of a unitary gate in the dynamic quantum circuit, such as the scheduled dynamic quantum circuit. A unitary gate, as used herein, refers to a quantum logic gate which acts on qubits that is represented by a unitary matrix.

In one embodiment, inserting engine 203 identifies unitary gates in the scheduled dynamic quantum circuit by analyzing the operators, such as operators created using the Operator function of Qiskit®, and then identifying such operators that correspond to unitary gates.

In one embodiment, inserting engine 203 inserts a dynamical decoupling sequence in the dynamic quantum circuit (e.g., dynamic quantum circuit 300) during the occurrence of a unitary gate in the scheduled dynamic quantum circuit using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the scheduled dynamic quantum circuit (e.g., dynamic quantum circuit 300) during the occurrence of a unitary gate in the scheduled dynamic quantum circuit using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of a unitary gate in the scheduled dynamic quantum circuit is provided in FIGS. 4B-4C. As illustrated in FIGS. 4B-4C, a dynamical decoupling sequence, such as a dynamical decoupling sequence comprised of delay gates 404′, is inserted during the occurrence of a unitary gate. In one embodiment, such a dynamical decoupling sequence may include a sequence of quantum gates that amount to the identity (I) so that they do not alter the logical action of the dynamic quantum circuit, but they have the effect of mitigating noise, such as decoherence, cross-talk, etc.

In this manner, noise is effectively mitigated in dynamic quantum circuits by inserting dynamical decoupling sequences in the dynamic quantum circuit (e.g., scheduled dynamic quantum circuit). For example, noise (e.g., decoupling, ZZ crosstalk) is suppressed using the dynamical decoupling sequence during feed-forward time.

Additionally, in this manner, dynamical decoupling sequences are inserted in the dynamic quantum circuit (e.g., scheduled dynamic quantum circuit) based on the context and identified condition, which considers connectivity to idling errors, measurement induced crosstalk error, ZZ crosstalk error during feed-forward time, etc.

Furthermore, in this manner, based on the connectivity of the qubits being measured during the middle of the quantum circuit, the feed-forward time may be extended (e.g., 2 times, 4 times), including utilizing staggered dynamical decoupling sequences.

A further description of these and other functions is provided below in connection with the discussion of the method for effectively mitigating noise in dynamic quantum circuits.

Prior to the discussion of the method for effectively mitigating noise in dynamic quantum circuits, a description of the hardware configuration of classical computer 102 (FIG. 1) is provided below in connection with FIG. 7.

Referring now to FIG. 7, in conjunction with FIG. 1, FIG. 7 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code 701 involved in performing the inventive methods, such as effectively mitigating noise in dynamic quantum circuits. In addition to block 701, computing environment 700 includes, for example, classical computer 102, network 113, such as a wide area network (WAN), end user device (EUD) 702, remote server 703, public cloud 704, and private cloud 705. In this embodiment, classical computer 102 includes processor set 706 (including processing circuitry 707 and cache 708), communication fabric 709, volatile memory 710, persistent storage 711 (including operating system 712 and block 701, as identified above), peripheral device set 713 (including user interface (UI) device set 714, storage 715, and Internet of Things (IoT) sensor set 716), and network module 717. Remote server 703 includes remote database 718. Public cloud 704 includes gateway 719, cloud orchestration module 720, host physical machine set 721, virtual machine set 722, and container set 723.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 718. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically classical computer 102, to keep the presentation as simple as possible. Classical computer 102 may be located in a cloud, even though it is not shown in a cloud in FIG. 7. On the other hand, classical computer 102 is not required to be in a cloud except to any extent as may be affirmatively indicated.

Processor set 706 includes one, or more, computer processors of any type now known or to be developed in the future. Processing circuitry 707 may be distributed over multiple packages, for example, multiple, coordinated integrated circuit chips. Processing circuitry 707 may implement multiple processor threads and/or multiple processor cores. Cache 708 is memory that is located in the processor chip package(s) and is typically used for data or code that should be available for rapid access by the threads or cores running on processor set 706. Cache memories are typically organized into multiple levels depending upon relative proximity to the processing circuitry. Alternatively, some, or all, of the cache for the processor set may be located “off chip.” In some computing environments, processor set 706 may be designed for working with qubits and performing quantum computing.

Computer readable program instructions are typically loaded onto classical computer 102 to cause a series of operational steps to be performed by processor set 706 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 708 and the other storage media discussed below. The program instructions, and associated data, are accessed by processor set 706 to control and direct performance of the inventive methods. In computing environment 700, at least some of the instructions for performing the inventive methods may be stored in block 701 in persistent storage 711.

Communication fabric 709 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 710 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 710 is located in a single package and is internal to classical computer 102, but, alternatively or additionally, the volatile memory may be distributed over multiple packages and/or located externally with respect to classical computer 102.

Persistent Storage 711 is any form of non-volatile storage for computers that is now known or to be developed in the future. The non-volatility of this storage means that the stored data is maintained regardless of whether power is being supplied to classical computer 102 and/or directly to persistent storage 711. Persistent storage 711 may be a read only memory (ROM), but typically at least a portion of the persistent storage allows writing of data, deletion of data and re-writing of data. Some familiar forms of persistent storage include magnetic disks and solid state storage devices. Operating system 712 may take several forms, such as various known proprietary operating systems or open source Portable Operating System Interface type operating systems that employ a kernel. The code included in block 701 typically includes at least some of the computer code involved in performing the inventive methods.

Peripheral device set 713 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 714 may include components such as a display screen, speaker, microphone, wearable devices (such as goggles and smart watches), keyboard, mouse, printer, touchpad, game controllers, and haptic devices. Storage 715 is external storage, such as an external hard drive, or insertable storage, such as an SD card. Storage 715 may be persistent and/or volatile. In some embodiments, storage 715 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 716 is made up of sensors that can be used in Internet of Things applications. For example, one sensor may be a thermometer and another sensor may be a motion detector.

Network module 717 is the collection of computer software, hardware, and firmware that allows classical computer 102 to communicate with other computers through WAN 113. Network module 717 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 717 are performed on the same physical hardware device. In other embodiments (for example, embodiments that utilize software-defined networking (SDN)), the control functions and the forwarding functions of network module 717 are performed on physically separate devices, such that the control functions manage several different network hardware devices. Computer readable program instructions for performing the inventive methods can typically be downloaded to classical computer 102 from an external computer or external storage device through a network adapter card or network interface included in network module 717.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 702 is any computer system that is used and controlled by an end user (for example, a customer of an enterprise that operates classical computer 102), and may take any of the forms discussed above in connection with classical computer 102. EUD 702 typically receives helpful and useful data from the operations of classical computer 102. For example, in a hypothetical case where classical computer 102 is designed to provide a recommendation to an end user, this recommendation would typically be communicated from network module 717 of classical computer 102 through WAN 113 to EUD 702. In this way, EUD 702 can display, or otherwise present, the recommendation to an end user. In some embodiments, EUD 702 may be a client device, such as thin client, heavy client, mainframe computer, desktop computer and so on.

Remote server 703 is any computer system that serves at least some data and/or functionality to classical computer 102. Remote server 703 may be controlled and used by the same entity that operates classical computer 102. Remote server 703 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 718 of remote server 703.

Public cloud 704 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 704 is performed by the computer hardware and/or software of cloud orchestration module 720. The computing resources provided by public cloud 704 are typically implemented by virtual computing environments that run on various computers making up the computers of host physical machine set 721, which is the universe of physical computers in and/or available to public cloud 704. The virtual computing environments (VCEs) typically take the form of virtual machines from virtual machine set 722 and/or containers from container set 723. It is understood that these VCEs may be stored as images and may be transferred among and between the various physical machine hosts, either as images or after instantiation of the VCE. Cloud orchestration module 720 manages the transfer and storage of images, deploys new instantiations of VCEs and manages active instantiations of VCE deployments. Gateway 719 is the collection of computer software, hardware, and firmware that allows public cloud 704 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 705 is similar to public cloud 704, except that the computing resources are only available for use by a single enterprise. While private cloud 705 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 704 and private cloud 705 are both part of a larger hybrid cloud.

Block 701 further includes the software components discussed above in connection with FIGS. 2-3, 4A-4C, 5A-5C and 6 to effectively mitigate noise in dynamic quantum circuits. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for effectively mitigating noise in dynamic quantum circuits, may be embodied in an application specific integrated circuit.

As stated above, a plethora of quantum algorithms have been traditionally formulated as static quantum circuits, where the computation is performed on an initially prepared quantum state, and all measurements are applied at the end of the circuit to extract the computational results. However, the recent advancements in quantum hardware have paved the way for a more flexible approach, allowing for measurements and qubit resets to be executed in the midst of a quantum circuit. Such quantum circuits are referred to as “dynamic quantum circuits” in that such circuits involve the evolution of the quantum state throughout the computation, periodic measurements of qubits mid-circuit (mid-circuit measurements) and concurrent processing of the resulting classical information on timescales shorter than the execution times of the circuits. Furthermore, dynamic quantum circuits allow “feed-forward operations,” which correspond to the real-time adaptation of the quantum circuit based on earlier measurement outcomes. Dynamic quantum circuits, as opposed to static quantum circuits, use less quantum resources thereby making quantum computations more efficient and less prone to decoherence (qubits of the computation become entangled with the environment). Furthermore, dynamic quantum circuits can transform large-depth circuits (depth of a quantum circuit is a measure of how many “layers” of quantum gates, executed in parallel, it takes to complete the computation defined by the circuit) into constant-depth circuits, which has an advantage in certain situations, such as preparing the Greenberger-Horne-Zeilinger state (type of entangled quantum state that involves at least three subsystems (particle states, qubits, or qudits)), gate teleportation (applying a quantum gate on an unknown state while it is being teleported), etc. Dynamic quantum circuits though, just like static quantum circuits, are subject to errors due to noise. However, dynamic quantum circuits are subject to errors due to noise in different manners that have not yet been adequately addressed. For example, during a mid-circuit measurement, a measurement performed on a qubit may result in dephasing on the other qubits connected to the same readout bus. In another example, during the feed-forward operation, ZZ crosstalk and decoherence may accumulate. ZZ crosstalk originates from a mixing between computational states and higher-energy states of the coupled qubits. It shifts the resonance frequency of one qubit conditionally on the state of another qubit. As a result, spurious phases are accumulated during gate operations, reducing fidelities. Quantum decoherence is the loss of quantum coherence, the process in which a system's behavior changes from what which can be explained by quantum mechanics to that which can be explained by classical mechanics. Unfortunately, there is not currently an effective means for suppressing or mitigating such types of noise (e.g., ZZ crosstalk, decoherence) in dynamic quantum circuits.

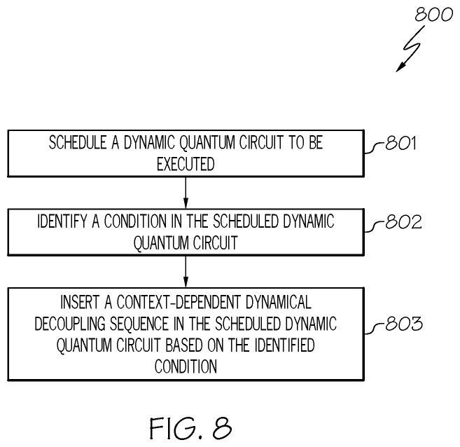

The embodiments of the present disclosure provide the means for effectively implementing noise mitigation in dynamic quantum circuits as discussed below in connection with FIG. 8.

FIG. 8 is a flowchart of a method 800 for effectively implementing noise mitigation in dynamic quantum circuits in accordance with an embodiment of the present disclosure.

Referring to FIG. 8, in conjunction with FIGS. 1-3, 4A-4C. 5A-5C, 6 and 7, in step 801, scheduling engine 201 of classical computer 102 schedules the dynamic quantum circuit to be executed. In one embodiment, scheduling engine 201 schedules the dynamic quantum circuit to be executed upon decomposing the dynamic quantum circuit into native gates and mapping of the dynamic quantum circuit onto a native topology.

As discussed above, in one embodiment, scheduling engine 201 uses the scheduler function of Qiskit® (e.g., qiskit.scheduler) to schedule a dynamic quantum circuit to be executed upon decomposing the dynamic quantum circuit into native gates and mapping of the dynamic quantum circuit onto a native topology. In one embodiment, the scheduler function (qiskit_ibm_provider.transpiler.passes.scheduling) of Qiskit® issues scheduling passes which determine when the dynamic quantum circuit is executed.

In one embodiment, scheduling engine 201 utilizes a function (IBMBackend) of Qiskit® to apply transformations and optimizations for the hardware backend when transpiling (process of rewriting a given input circuit to match the topology of a specific quantum device and/or to optimize the quantum circuit for execution on noisy quantum systems). In one embodiment, scheduling engine 201 utilizes the qiskit.transpiler function of Qiskit® to perform such transpilation.

In one embodiment, scheduling engine 201 utilizes the scheduler function of Qiskit® (e.g., qiskit.scheduler) to optimize execution of the dynamic quantum circuit by adjusting gate times and orders based on mid-circuit measurements.

In step 802, identifying engine 202 of classical computer 102 identifies a condition in the scheduled dynamic quantum circuit.

As stated above, a “condition,” as used herein, refers to a situation or circumstance used to identify or detect a source of noise in the dynamic quantum circuit that may result in an error occurring in the dynamic quantum circuit. For example, the condition may correspond to the idling times, spectator qubits, and idling qubits in cross-talk resistant states (quantum states |0 [symbol] and |1 [symbol] ) in the dynamic quantum circuit.

Idling times, as used herein, refer to locations in the dynamic quantum circuit where no operations are being performed. During such a situation, a qubit may be susceptible to idling errors, which occur when the qubit is idle and not actively undergoing any operations.

Identifying engine 202 identifies idling times by scanning the dynamic quantum circuit for idle periods of time. In one embodiment, identifying engine 202 identifies idling times based on the duration of the instruction on the qubits, which may be obtained from the InstructionDurations function of Qiskit®. After obtaining the duration of the instruction on the qubits, idling times may then be identified when an operation is not being performed. An illustration of identifying an idling time is provided in FIG. 3.

For example, as shown in FIG. 3, idling time 307 is identified in which an idling and dephasing error may occur. For example, qubit q₅ undergoes a mid-circuit measurement; however, qubits q₄ and q₆ undergo dephasing due to the sharing of the readout bus. Furthermore, as illustrated in FIG. 3, after the measurement of qubit q₅, which is either in the quantum state of |0 [symbol] or |1 [symbol] , qubit q₅ is not prone to crosstalk or dephasing errors. However, during feed-forward operation 308, which occurs after the mid-circuit measurement, qubits q₄ and q₆ are prone to crosstalk and dephasing errors.

Furthermore, spectator qubits, as used herein, refer to qubits with the role of measuring outside noise rather than storing data. Such spectator qubits, which are co-located together with the data qubits that are used in the computation, may be utilized for noise detection. For example, the spectator qubits are not participating in the quantum computation itself, meaning that they will not become entangled with the data qubits. Instead, the spectator qubits can be used to monitor noise that would affect the data qubits. Since the spectator qubits are co-located with the data qubits, they can experience the same noise that the data qubits experience. As a result, in one embodiment, identifying engine 202 performs a measurement on spectator qubits to estimate what that noise is in real-time when a quantum computation is running on the data qubits. This noise measurement is then used to detect noise occurring in the dynamic quantum circuit. In such an embodiment, the noise, the spectator qubit and the data qubit experience are correlated.

In one embodiment, identifying engine 202 identifies spectator qubits in the scheduled dynamic quantum circuit based on the information provided by scheduling engine 201, which may designate certain qubits of the dynamic quantum circuit to correspond to the spectator qubits based on input from a user.

Idling qubits, as used herein, refers to those qubits that are not currently being processed by the dynamic quantum circuit. Cross-talk resistant states, as used herein, refer to those states, such as quantum states |0 [symbol] and |1 [symbol] that prevent cross-talk from occurring in the dynamic quantum circuit.

In one embodiment, identifying engine 202 identifies idling qubits in the cross-talk resistant states by identifying idling times for qubits based on scanning the dynamic quantum circuit for idle periods of time or based on the duration of the instruction on the qubits, which may be obtained from the InstructionDurations function of Qiskit®, and then obtaining the measurements of the quantum states for the qubits during such idling times from measurement operators (e.g., measurement operator 305).

In step 803, inserting engine 203 of classical computer 102 inserts a context-dependent dynamical decoupling sequence in the scheduled dynamic quantum circuit based on the identified condition, such as idling times, spectator qubits or idling qubits in cross-talk resistant states, in the dynamic quantum circuit.

As discussed above, a dynamical decoupling sequence, as used herein, is an open-loop quantum control technique employed in quantum computing to suppress noise, such as cross-talk, decoherence, etc. For example, in one embodiment, a dynamical decoupling sequence corresponds to a sequences of qubit gates to suppress unwanted noise, such as cross-talk, decoherence, etc. A “context-dependent” dynamical decoupling sequence, as used herein, refers to a dynamical decoupling sequence that is inserted in the scheduled dynamic quantum circuit based on the context, such as the occurrence of particular operations. As discussed further below, such particular operations include mid-circuit operations, the occurrence of a feed-forward operation, the occurrence of qubit sharing, the occurrence of qubit swapping, and the occurrence of a unitary gate in the dynamic quantum circuit.

In one embodiment, inserting engine 203 inserts the dynamical decoupling sequence in the dynamic quantum circuit during a mid-circuit measurement. A “mid-circuit measurement,” as used herein, refers to a measurement that occurs within the middle of the quantum circuit, i.e., the measurement does not occur at the beginning or end of the quantum circuit. Dynamical decoupling sequences (sequences of qubit gates) may be utilized to suppress the dephasing introduced by a readout bus (e.g., readout bus 306 of FIG. 3) during mid-circuit measurements as well as the large idling errors accumulated during long mid-circuit measurements. As a result, a dynamical decoupling sequence may be inserted in the dynamic quantum circuit during a mid-circuit measurement as illustrated in FIGS. 4A-4C.

For example, a dynamical decoupling sequence 401 is inserted in dynamic quantum circuit 300 during idling time 307, which occurs during a mid-circuit measurement performed by measurement operator 402. In one embodiment, inserting engine 203 identifies such a mid-circuit measurement based on identifying measurement operator 402 performing a mid-circuit measurement. In one embodiment, inserting engine 203 identifies such a measurement operator 402 by analyzing the operators, such as measurement operators, created using the Operator function of Qiskit®, and then identifying such measurement operators that are scheduled to perform mid-circuit measurements.

As discussed above, inserting engine 203 is configured to insert dynamical decoupling sequence 401 during a mid-circuit measurement performed by measurement operator 402. Such a dynamical decoupling sequence 401 may include a sequence of quantum gates, such as Pauli X gates 403 and delay gates 404. In one embodiment, the sequence of quantum gates amount to the identity (I) so that they do not alter the logical action of the dynamic quantum circuit, but they have the effect of mitigating noise, such as decoherence, cross-talk, etc.

In one embodiment, inserting engine 203 inserts dynamical decoupling sequence 401 in dynamic quantum circuit 300 using the DynamicalDecoupling function of Qiskit® in which the dynamical decoupling sequence (sequence of gates to be applied) is specified as a parameter (e.g., dd_sequence).

In one embodiment, inserting engine 203 inserts dynamical decoupling sequence 401 in dynamic quantum circuit 300 using a dynamical decoupling insertion pass which works on a scheduled dynamic quantum circuit. Such a dynamical decoupling insertion pass may be implemented using the PadDynamicalDecoupling function of Qiskit®.

Furthermore, in one embodiment, inserting engine 203 inserts the dynamical decoupling sequence in the dynamic quantum circuit during the occurrence of a feed-forward operation.

In one embodiment, since no quantum gates can be applied during the feed-forward time (T), the same feed-forward time (T) is added so that for the two-qubit case, one has (X⊗I)f_{T}(X⊗I)f_{T}, where f_{T}=exp(-iH_{sys}T), which is the free evolution for the system for time T.

In one embodiment, the second qubit is measured so that it is in either in the quantum state of |0 [symbol] or |1 [symbol] . Furthermore, by applying X pulses on the first qubit, ZZ crosstalk and decoherence are suppressed on the first qubit.

In one embodiment, such a procedure can be extended to a larger quantum circuit, such as the scheduled dynamic quantum circuit. For example, when every other qubit is measured, and the connectivity is such that all the qubits lie on a 1-dimensional chain, the feed-forward time can be extended, such as to 2 or 4 times T while inserting staggered dynamical decoupling sequences on all the qubits. Such a process may be implemented for the heavy-hex lattice architecture (each unit cell of the lattice consists of a hexagonal arrangement of qubits, with an additional qubit on each edge) as well as the square lattice architecture (e.g., four superconducting qubits on a chip roughly one-quarter-inch square) with different sequences and delays.

An illustration of inserting engine 203 inserting a dynamical decoupling sequence in a feed-forward operation is provided in FIGS. 4A-4C.

Referring to FIGS. 4A-4C, a dynamical decoupling sequence 405 is inserted in dynamic quantum circuit 300 during feed-forward operation 308. In one embodiment, inserting engine 203 identifies such a feed-forward operation (e.g., feed-forward operation 308 of FIGS. 3 and 4A-4C) by analyzing the operators, such as operators to perform a feed-forward operation, created using the Operator function of Qiskit®, and then identifying such operators that are scheduled to perform a feed-forward operation.

Furthermore, as shown in FIG. 4C, dynamical decoupling sequence 405 may include a sequence of quantum gates, such as Pauli X gates 403 and delay gates 404. In one embodiment, the sequence of quantum gates amount to the identity (I) so that they do not alter the logical action of the dynamic quantum circuit, but they have the effect of mitigating noise, such as decoherence,

In one embodiment, inserting engine 203 inserts dynamical decoupling sequence 405 in dynamic quantum circuit 300 using the DynamicalDecoupling function of Qiskit® in which the dynamical decoupling sequence (sequence of gates to be applied) is specified as a parameter (e.g., dd_sequence).

In one embodiment, inserting engine 203 inserts dynamical decoupling sequence 405 in dynamic quantum circuit 300 using a dynamical decoupling insertion pass which works on a scheduled dynamic quantum circuit. Such a dynamical decoupling insertion pass may be implemented using the PadDynamicalDecoupling function of Qiskit®.

A further illustration of inserting engine 203 inserting dynamical decoupling sequence 405 in dynamic quantum circuit 300 is provided in FIGS. 5A-5C.

As shown in FIGS. 5A-5C, the feed-forward time is extended (see element 501), such as to 2 times T, while applying the dynamical decoupling (DD) sequences (see element 502) to qubits q₄ and q₆ after a mid-circuit measurement (MCM) since q₅ is known to be in a computational state (following a projective measurement). In such an embodiment, noise, such as ZZ crosstalk, is suppressed (see element 504). In one embodiment, such a dynamical decoupling sequence (e.g., dynamical decoupling sequence 502) may include a sequence of quantum gates that amount to the identity (I) so that they do not alter the logical action of the dynamic quantum circuit, but they have the effect of mitigating noise, such as decoherence, cross-talk, etc.

In the more general case, staggered dynamical decoupling sequences are inserted on the qubits. For example, when qubits q₄, q₅ and q₆ are all in an arbitrary state, a staggered dynamical decoupling sequence is inserted in dynamic quantum circuit 300. In such an embodiment, the idle time is extended to 4 times T so that the staggered dynamical decoupling sequences can be inserted on all the qubits as illustrated in FIG. 6.

Referring to FIG. 6, in conjunction with FIGS. 5A-5C, if qubits q₄, q₅ and q₆ are all in an arbitrary state and qubits q₄, q₅ and q₆ are coupled in a chain, then qubit q₆ may follow the same pattern as qubit q₄ (referred to herein as “Pattern A”) and qubit q₅ has its pulses (identified by the “Xs” in FIG. 6) staggered with respect to qubit q₄ (referred to herein as “Pattern B”). This is assuming that the connectivity is q₄₋q₅₋q₆, i.e., q₄ and q₆ are not coupled. It is noted that this factor of 4 in timing (the original latency, which is referred to as the switch latency T, corresponds to element 601) works for graphs when max connectivity=3, such as the heavy hex topology. In the embodiment discussed above, the graph can be divided into two subgraphs such that each qubit follows pattern A or B (and no coupled qubits have the same pattern). For larger connectivity, more sequences are necessary and the added delays are increased.

In one embodiment, the application of the dynamical decoupling sequence may differ in the presence of ZZ coupling depending on the state of the coupled qubits. In one embodiment, if one of the two coupled qubits is in either the |0 [symbol] or |1 [symbol] quantum state (as opposed to an arbitrary state), then a dynamical decoupling sequence is not applied on that qubit. In such an embodiment, a dynamical decoupling sequence is applied on the other qubit, assuming that it is not coupled to any other qubit. If it is coupled to another qubit (third qubit), then the timing of the dynamical decoupling sequence is staggered, such as with respect to the third qubit.

If, however, both qubits are in an arbitrary state, then staggered dynamical decoupling sequences are applied on both qubits (e.g., same dynamical decoupling sequences are applied on both qubits but with staggered timing).

If, however, both qubits are in the |0 [symbol] or |1 [symbol] quantum state, then a dynamical decoupling sequence is not applied on them.

In one embodiment, inserting engine 203 inserts the dynamical decoupling sequence in the dynamic quantum circuit during the occurrence of qubit shuttling. Qubit shuttling, as used herein, refers to the ability to move qubits while preserving their quantum state.

In one embodiment, inserting engine 203 identifies qubit shuttling by identifying a shuttling-based two-qubit logic gate in the dynamic quantum circuit. In one embodiment, inserting engine 203 identifies such logic gates by analyzing the operators, such as operators to perform a shuttling-based two-qubit logic gate, created using the Operator function of Qiskit®, and then identifying such operators that are scheduled to perform the shuttling-based two-qubit logic gate.

In another embodiment, inserting engine 203 identifies the shuttle operations in the quantum program to perform qubit shuttling. In one embodiment, inserting engine 203 identifies such shuttle operations by analyzing the operators, such as operators to perform a qubit shuttle operation, created using the Operator function of Qiskit®, and then identifying such operators that are scheduled to perform the qubit shuttling.

In one embodiment, inserting engine 203 inserts a dynamical decoupling sequence in the dynamic quantum circuit (e.g., dynamic quantum circuit 300) during the occurrence of qubit shuttling using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the dynamic quantum circuit (e.g., dynamic quantum circuit 300) during the occurrence of qubit shuttling using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of qubit shuttling is provided in FIG. 4B. As illustrated in FIG. 4B, a dynamical decoupling sequence, such as dynamical decoupling sequence 406 comprised of delay gates 404, is inserted during the occurrence of qubit shuttling. In one embodiment, such a dynamical decoupling sequence 406 may include a sequence of quantum gates that amount to the identity (I) so that they do not alter the logical action of the dynamic quantum circuit, but they have the effect of mitigating noise, such as decoherence, cross-talk, etc.

In one embodiment, inserting engine 203 inserts the dynamical decoupling sequence in the dynamic quantum circuit during the occurrence of qubit swapping. Qubit swapping, as used herein, refers to moving information from one qubit to another non-adjacent qubit.

In one embodiment, inserting engine 203 identifies qubit swapping by performing the swap test, which is a procedure in quantum computation that is used to check how much two quantum states differ. In one embodiment, the swap test is implemented in Qiskit®.

In one embodiment, inserting engine 203 identifies such swap operations by identifying swap gates (swaps the state of the two qubits involved in the operation) in the dynamic quantum circuit. In one embodiment, inserting engine 203 identifies such swap operations by analyzing the operators, such as operators to perform a qubit swap operation, created using the Operator function of Qiskit®, and then identifying such operators that are scheduled to perform the qubit swapping.

In one embodiment, inserting engine 203 inserts a dynamical decoupling sequence in the dynamic quantum circuit (e.g., dynamic quantum circuit 300) during the occurrence of qubit swapping using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the dynamic quantum circuit (e.g., dynamic quantum circuit 300) during the occurrence of qubit swapping using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of qubit swapping is provided in FIGS. 4B-4C. As illustrated in FIGS. 4B-4C, a dynamical decoupling sequence, such as dynamical decoupling sequence 407 comprised of delay gates 404, is inserted during the occurrence of qubit swapping. In one embodiment, such a dynamical decoupling sequence 407 may include a sequence of quantum gates that amount to the identity (I) so that they do not alter the logical action of the dynamic quantum circuit, but they have the effect of mitigating noise, such as decoherence, cross-talk, etc.

In one embodiment, inserting engine 203 inserts the dynamical decoupling sequence in the dynamic quantum circuit during the occurrence of a unitary gate in the dynamic quantum circuit, such as the scheduled dynamic quantum circuit. A unitary gate, as used herein, refers to a quantum logic gate which acts on qubits that is represented by a unitary matrix.

In one embodiment, inserting engine 203 identifies unitary gates in the scheduled dynamic quantum circuit by analyzing the operators, such as operators created using the Operator function of Qiskit®, and then identifying such operators that correspond to unitary gates.

In one embodiment, inserting engine 203 inserts a dynamical decoupling sequence in the dynamic quantum circuit (e.g., dynamic quantum circuit 300) during the occurrence of a unitary gate in the scheduled dynamic quantum circuit using the DynamicalDecoupling function of Qiskit® in which the dynamical decoupling sequence (sequence of gates to be applied) is specified as a parameter (e.g., dd_sequence).

In one embodiment, inserting engine 203 inserts a dynamical decoupling sequence in the scheduled dynamic quantum circuit (e.g., dynamic quantum circuit 300) during the occurrence of a unitary gate in the scheduled dynamic quantum circuit using a dynamical decoupling insertion pass which works on a scheduled dynamic quantum circuit. Such a dynamical decoupling insertion pass may be implemented using the PadDynamicalDecoupling function of Qiskit®.

An example of such a dynamical decoupling sequence inserted during the occurrence of a unitary gate in the scheduled dynamic quantum circuit is provided in FIGS. 4B-4C. As illustrated in FIGS. 4B-4C, a dynamical decoupling sequence, such as a dynamical decoupling sequence comprised of delay gates 404′, is inserted during the occurrence of a unitary gate. In one embodiment, such a dynamical decoupling sequence may include a sequence of quantum gates that amount to the identity (I) so that they do not alter the logical action of the dynamic quantum circuit, but they have the effect of mitigating noise, such as decoherence, cross-talk, etc.

As a result of the foregoing, noise is effectively mitigated in dynamic quantum circuits by inserting dynamical decoupling sequences in the dynamic quantum circuit (e.g., scheduled dynamic quantum circuit). For example, noise (e.g., decoupling, ZZ crosstalk) is suppressed using the dynamical decoupling sequence during feed-forward time.

Additionally, the principles of the present disclosure insert dynamical decoupling sequences in the dynamic quantum circuit (e.g., scheduled dynamic quantum circuit) based on the context and the identified condition, which considers connectivity to idling errors, measurement induced crosstalk error, ZZ crosstalk error during feed-forward time, etc.

Furthermore, based on the connectivity of the qubits being measured during the middle of the quantum circuit, the principles of the present disclosure extended the feed-forward time (e.g., 2 times, 4 times), including utilizing staggered dynamical decoupling sequences.

Furthermore, the principles of the present disclosure improve the technology or technical field involving dynamic quantum circuits.

As discussed above, a plethora of quantum algorithms have been traditionally formulated as static quantum circuits, where the computation is performed on an initially prepared quantum state, and all measurements are applied at the end of the circuit to extract the computational results. However, the recent advancements in quantum hardware have paved the way for a more flexible approach, allowing for measurements and qubit resets to be executed in the midst of a quantum circuit. Such quantum circuits are referred to as “dynamic quantum circuits” in that such circuits involve the evolution of the quantum state throughout the computation, periodic measurements of qubits mid-circuit (mid-circuit measurements) and concurrent processing of the resulting classical information on timescales shorter than the execution times of the circuits. Furthermore, dynamic quantum circuits allow “feed-forward operations,” which correspond to the real-time adaptation of the quantum circuit based on earlier measurement outcomes. Dynamic quantum circuits, as opposed to static quantum circuits, use less quantum resources thereby making quantum computations more efficient and less prone to decoherence (qubits of the computation become entangled with the environment). Furthermore, dynamic quantum circuits can transform large-depth circuits (depth of a quantum circuit is a measure of how many “layers” of quantum gates, executed in parallel, it takes to complete the computation defined by the circuit) into c onstant-depth circuits, which has an advantage in certain situations, such as preparing the Greenberger-Horne-Zeilinger state (type of entangled quantum state that involves at least three subsystems (particle states, qubits, or qudits)), gate teleportation (applying a quantum gate on an unknown state while it is being teleported), etc. Dynamic quantum circuits though, just like static quantum circuits, are subject to errors due to noise. However, dynamic quantum circuits are subject to errors due to noise in different manners that have not yet been adequately addressed. For example, during a mid-circuit measurement, a measurement performed on a qubit may result in dephasing on the other qubits connected to the same readout bus. In another example, during the feed-forward operation, ZZ crosstalk and decoherence may accumulate. ZZ crosstalk originates from a mixing between computational states and higher-energy states of the coupled qubits. It shifts the resonance frequency of one qubit conditionally on the state of another qubit. As a result, spurious phases are accumulated during gate operations, reducing fidelities. Quantum decoherence is the loss of quantum coherence, the process in which a system's behavior changes from what which can be explained by quantum mechanics to that which can be explained by classical mechanics. Unfortunately, there is not currently an effective means for suppressing or mitigating such types of noise (e.g., ZZ crosstalk, decoherence) in dynamic quantum circuits.

Embodiments of the present disclosure improve such technology by identifying a condition in a scheduled dynamic quantum circuit, such as idling times, spectator qubits, and idling qubits in cross-talk resistant states (quantum states |0 [symbol] and |1 [symbol] . Idling times, as used herein, refer to locations in the dynamic quantum circuit where no operations are being performed. Spectator qubits, as used herein, refer to qubits with the role of measuring outside noise rather than storing data. Idling qubits, as used herein, refer to those qubits that are not currently being processed by the dynamic quantum circuit. Upon identifying such a condition in the dynamic quantum circuit, a context-dependent dynamical decoupling sequence is inserted in the dynamic quantum circuit based on the identified condition. A dynamical decoupling sequence, as used herein, is an open-loop quantum control technique employed in quantum computing to suppress noise, such as cross-talk, decoherence, etc. For example, in one embodiment, a dynamical decoupling sequence corresponds to a sequence of qubit gates to suppress unwanted noise, such as cross-talk, decoherence, etc. A “context-dependent” dynamical decoupling sequence, as used herein, refers to a dynamical decoupling sequence that is inserted in the dynamic quantum circuit based on the context, such as the occurrence of a particular operation. For example, the dynamical decoupling sequence is inserted in the dynamic quantum circuit during a mid-circuit measurement, the occurrence of a feed-forward operation, the occurrence of qubit shuttling (the ability to move qubits while preserving their quantum state), the occurrence of qubit swapping (moving information from one qubit to another non-adjacent qubit), and the occurrence of a unitary gate in the dynamic quantum circuit. In this manner, noise is effectively mitigated in dynamic quantum circuits. Furthermore, in this manner, there is an improvement in the technical field involving dynamic quantum circuits.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for implementing noise mitigation in dynamic quantum circuits, the method comprising:
identifying a condition in a dynamic quantum circuit; and
inserting a context-dependent dynamical decoupling sequence in said dynamic quantum circuit based on said identified condition.

2. The method as recited in claim 1, wherein said condition comprises one of the following in the group consisting of an idling time, spectator qubits and idling qubits in cross-talk resistant states in said dynamic quantum circuit. cm 3. The method as recited in claim 1, wherein said dynamical decoupling sequence is inserted in said dynamic quantum circuit during a mid-circuit measurement.

4. The method as recited in claim 1, wherein said dynamical decoupling sequence is inserted in said dynamic quantum circuit during an occurrence of a feed-forward operation.

5. The method as recited in claim 1, wherein said dynamical decoupling sequence is inserted in said dynamic quantum circuit during an occurrence of qubit shuttling or qubit swapping.

6. The method as recited in claim 1, wherein said dynamical decoupling sequence is inserted in said dynamic quantum circuit during an occurrence of a unitary gate in said dynamic quantum circuit.

7. The method as recited in claim 1 further comprising:
scheduling said dynamic quantum circuit to be executed upon decomposing said dynamic quantum circuit into native gates and mapping of said dynamic quantum circuit onto a native topology, wherein said condition is identified in said scheduled dynamic quantum circuit.

8. A computer program product for implementing noise mitigation in dynamic quantum circuits, the computer program product comprising one or more computer readable storage mediums having program code embodied therewith, the program code comprising programming instructions for:
identifying a condition in a dynamic quantum circuit; and
inserting a context-dependent dynamical decoupling sequence in said dynamic quantum circuit based on said identified condition.

9. The computer program product as recited in claim 8, wherein said condition comprises one of the following in the group consisting of an idling time, spectator qubits and idling qubits in cross-talk resistant states in said dynamic quantum circuit.

10. The computer program product as recited in claim 8, wherein said dynamical decoupling sequence is inserted in said dynamic quantum circuit during a mid-circuit measurement.

11. The computer program product as recited in claim 8, wherein said dynamical decoupling sequence is inserted in said dynamic quantum circuit during an occurrence of a feed-forward operation.

12. The computer program product as recited in claim 8, wherein said dynamical decoupling sequence is inserted in said dynamic quantum circuit during an occurrence of qubit shuttling or qubit swapping.

13. The computer program product as recited in claim 8, wherein said dynamical decoupling sequence is inserted in said dynamic quantum circuit during an occurrence of a unitary gate in said dynamic quantum circuit.

14. The computer program product as recited in claim 8, wherein the program code further comprises the programming instructions for:
scheduling said dynamic quantum circuit to be executed upon decomposing said dynamic quantum circuit into native gates and mapping of said dynamic quantum circuit onto a native topology, wherein said condition is identified in said scheduled dynamic quantum circuit.

15. A system, comprising:
a memory for storing a computer program for implementing noise mitigation in dynamic quantum circuits; and
a processor connected to said memory, wherein said processor is configured to execute program instructions of the computer program comprising:
identifying a condition in a dynamic quantum circuit; and
inserting a context-dependent dynamical decoupling sequence in said dynamic quantum circuit based on said identified condition.

16. The system as recited in claim 15, wherein said condition comprises one of the following in the group consisting of an idling time, spectator qubits and idling qubits in cross-talk resistant states in said dynamic quantum circuit.

17. The system as recited in claim 15, wherein said dynamical decoupling sequence is inserted in said dynamic quantum circuit during a mid-circuit measurement.

18. The system as recited in claim 15, wherein said dynamical decoupling sequence is inserted in said dynamic quantum circuit during an occurrence of a feed-forward operation.

19. The system as recited in claim 15, wherein said dynamical decoupling sequence is inserted in said dynamic quantum circuit during an occurrence of qubit shuttling or qubit swapping.

20. The system as recited in claim 15, wherein said dynamical decoupling sequence is inserted in said dynamic quantum circuit during an occurrence of a unitary gate in said dynamic quantum circuit.
